(19) United States
(12) Patent Application Publication
(10) Pub. No.: US 2025/0010743 A1
(43) Pub. Date: Jan. 9, 2025

(54) Charging Train Device for a Motor Vehicle

(71) Applicant: Bayerische Motoren Werke AKtiengesellschaft, Muenchen (DE)

(72) Inventor: Bernd NURTSCH, Gars-Bahnhof (DE)

(21) Appl. No.: 18/712,091

(22) PCT Filed: Nov. 10, 2022
(86) PCT No.: PCT/EP2022/081481

§ 371 Date: May 21, 2024

(30) Foreign Application Priority Data
Dec. 9, 2021 (DE) 10 2021 132 397.5

(51) Int. Cl. B60L 53/302; B60L 53/16; H01B 5/00

(52) U.S. Cl. CPC B60L 53/302; B60L 53/16; H01B 5/002

(57) ABSTRACT

A charging train device for a battery of a motor vehicle including a charging train that has at least one cable and respective ends on the battery side and on a charging interface side for connection to a vehicle-external charging station, and in which charging train a cooling channel arrangement is located through which a cooling fluid can flow and which comprises at least one cooling channel, wherein the cooling fluid is an immersion fluid.

### BACKGROUND AND SUMMARY

The invention concerns a charging train device for a battery of a motor vehicle, with a charging train which has at least one line and respective ends on the battery side and on a charging interface side for connection to a vehicle-external charging station, and in which a cooling channel arrangement is arranged through which a cooling fluid can flow and which comprises at least one cooling channel.

US 2016/0 200 206 Al describes a charging system for an electrically powered vehicle. The charging system comprises an energy source and a cable which is attached at one end to the energy source and at the other end to a connecting element of the charging system. The connecting element can be connected to a charging port of the electrically powered motor vehicle in order to charge the motor vehicle. The charging system is thus a vehicle-external charging system by which electrical energy can be provided for charging the motor vehicle. It is provided that the cable and the connecting element are cooled by a cooling circuit, so that the charging system can provide the electrical energy for the motor vehicle with a particularly high power level.

When electrical energy is provided by the charging system with a particularly high power level, a charging rate of the motor vehicle battery depends on a maximum capacity of the motor vehicle for receiving the electrical energy. In order to allow a particularly high capacity of the motor vehicle for receiving the electrical energy, it is suitable also to cool the charging train, the ends of which connect the battery to the charging interface for connection to the vehicle-external charging station.

For example, here DE 10 2018 215 875 A1 describes a charging train device for a battery of a motor vehicle, having a charging train which comprises at least one line and respective ends on the battery side and for connection to a vehicle-external charging station. To cool the charging train device, a cooling channel is arranged in the charging train, through which a cooling fluid can flow. For this, the at least one line may have a cooling channel through which the cooling fluid can flow. It is proposed to use a water-glycol mixture as a cooling fluid.

This requires electrical insulation of the cooling channel for conducting the cooling fluid. Cooling the charging train device allows a particularly high transmission power of electrical energy from the vehicle-side charging interface to the battery of the motor vehicle.

An object of the present invention is to create a structurally and functionally improved charging device for a battery of a motor vehicle which allows a particularly high capacity of the motor vehicle for receiving the electrical energy.

This object is achieved according to the invention by a charging train device for a battery of a motor vehicle with the features disclosed herein. Advantageous embodiments of the invention are also disclosed herein.

A charging train device is proposed for a battery of a motor vehicle. The battery is in particular a high-voltage accumulator, by which electrical energy can be provided for an electric drive of the motor vehicle in order to drive the motor vehicle electrically. The motor vehicle is in particular an electrically powered vehicle, in particular an electrically powered car. The charging train device has at least one line and respective ends on the battery side and on the charging interface side for connection to a vehicle-external charging station. The at least one line is thus in particular a charging cable. A cooling channel arrangement, through which a cooling fluid can flow and which comprises at least one cooling channel, is arranged in the charging train. The charging train device is distinguished in that the cooling fluid is an immersion fluid.

In order to allow a particularly high capacity of the motor vehicle for receiving electrical energy from the vehicle-external charging station, as in DE 10 2018 215 875 A, it is proposed that the cooling channel arrangement can be supplied with the cooling fluid via a cooling device arranged on the vehicle side. The charging train thus electrically connects the vehicle-side charging interface, which can be connected to a corresponding connecting element on the vehicle-external charging station, to the battery of the motor vehicle. This means that the at least one line can be electrically connected to the battery and to the vehicle-side charging interface. The vehicle-side charging interface constitutes a charging element in the form of the charging socket. The charging train comprising the at least one line has for example two connection elements, one of which is arranged at each end of the charging train. Via these connection elements, the charging train can be electrically connected to the battery and to the vehicle-side charging interface for transmission of electrical energy.

In order to cool the charging train device, the at least one line has the cooling channel arrangement through which the cooling fluid can flow. The charging channel arrangement is fluidically connected not only to the connection elements but also to the at least one line. According to the invention, an immersion fluid, e.g. a fluorine- or paraffin-based oil, is used as the cooling fluid. Thus the charging train is cooled by a cooling fluid which has electrically insulating properties.

The use of an electrically insulating cooling fluid allows the desired simple mechanical structure, since no special precautions need be taken with respect to insulation. Immersion cooling has previously been used only for transformers. Immersion cooling allows cooling of live conductors both from the inside (internal cooling) and from the outside (external cooling). A further advantage of immersion cooling is that no separate heat exchangers need be provided to allow the desired cooling performance. This further promotes the desired simple mechanical structure.

At the same time, because of the cooling, the charging train can transmit a particularly high electrical power from the vehicle-side charging interface to the battery, which is particularly important if the charging train and its at least one line are configured as high-voltage conductors. It is known that a temperature in the charging train, as a transmission medium, rises higher, the higher the transmission power of the electrical energy to be transmitted in the charging train. A maximum temperature for the transmission medium thus defines a maximum electrical energy transmission power of the transmission medium if the transmission medium is uncooled.

If heat is actively removed from the live transmission medium and hence the charging train by the immersion fluid, a particularly high electrical energy transmission power can be implemented since because of the cooling, on transmission of electrical energy, the transmission medium does not heat up as greatly as with uncooled transmission medium, and thus the maximum temperature is only reached at a maximum transmission power which is higher than in comparison with uncooled transmission medium. Since cooling takes place over the entire length of the charging train and its at least one line, the cooled charging train device allows a particularly high electrical energy transmission power from the vehicle-side charging interface to the battery of the motor vehicle. Accordingly, this allows a particularly high capacity of the motor vehicle for receiving electrical energy from the vehicle-external charging station.

According to a suitable embodiment, the charging train comprises a line pair consisting of a first line and a second line. In other words, the battery and the vehicle-side charging interface are connected together via the two lines. Here, the lines preferably run parallel or substantially parallel throughout from the battery to the vehicle-side charging interface.

Suitably, the cooling channel arrangement comprises a corresponding cooling channel pair consisting of a first cooling channel and a second cooling channel. In other words, the lines connecting the battery and the vehicle-side charging interface are cooled by the cooling channel pair over the entire length. As a result, not only do the lines from the battery to the vehicle-side charging interface run in parallel, but also the corresponding cooling channels of the cooling channel arrangement.

A further suitable embodiment provides that the cooling channel arrangement is configured as a closed cooling circuit. A deflector is provided at the respective ends on the battery side and on the charging interface side, by which cooling fluid can be deflected from at least one of the cooling channels into at least another of the cooling channels, wherein the cooling fluid is conveyed into the cooling circuit via a pump. By the respective deflector, a cooling fluid received from one of the lines is introduced into another of the lines by the deflector. Thus the cooling fluid flows into a first of the lines from the battery towards the vehicle-side charging interface, and into another of the lines from the vehicle-side charging interface towards the battery. The deflector may be arranged at the end of the charging train assigned to the battery and/or at the end assigned to the vehicle-side charging interface. The deflector is for example arranged in or in the vicinity of one of the connection elements. Alternatively, the deflector may be integrated into the charging interface. Preferably, the deflector is provided as close as possible to the charging interface.

A flow direction of the cooling fluid in the two cooling channels runs in opposite directions because of the deflector. This leads to a U-shaped cooling channel conduction which forms a closed cooling circuit. This allows a particularly simple and effective cooling of the charging train.

According to a further suitable embodiment, the pump is arranged in an expansion vessel of the cooling circuit and conveys the cooling fluid in the circuit through the two cooling channels. Thus the cooling device may be formed compactly. In the expansion vessel, the pump draws in cooling fluid from one of the cooling channels and expels the cooling fluid into the other of the cooling channels. The compensation vessel constitutes a return for the pump.

It is furthermore suitable that the cooling circuit is a cooling circuit independent of the battery cooling. Thus, independently of the cooling fluid used for battery cooling, immersion fluid can be used as a cooling fluid for the charging train device. Thus the charging train device can be efficiently cooled with structurally simple means. In addition, a structurally simple design is possible.

According to a first alternative, the at least one line of the charging train is a hollow conductor, wherein the cooling fluid is guided in the interior of the hollow conductor. In other words, an internal cooling of the at least one line of the charging train is provided, whereby line and cooling channel form a unit. Because of the electrically insulating properties of the immersion fluid, no electrical insulation precautions are required. Thus an inner wall of the hollow conductor need not be clad with an electrical insulator. In other words, the inner wall of the hollow conductor is configured without electrical insulator, which makes the design and production of the conductor particularly simple.

It is furthermore suitable if the lines of the charging train are each formed as rectangular conductors, at least in a portion at their respective ends on the battery side and on the charging interface side, preferably over their entire length. The rectangular conductors are in particular high-voltage conductors. Thus the lines of the charging train can be arranged physically close to one another, whereby simultaneously a spatially compact charging train arrangement is achieved. Also, the closed cooling circuit can be implemented in a particularly simple fashion.

For this it is suitable if the rectangular conductors lie one above the other. In particular, it is provided that each rectangular conductor has an opening at its respective ends on the battery side and/or the charging interface side, which openings face one another. The two openings may serve as the deflector, by which the cooling fluid can be deflected from at least one of the cooling channels into at least one of the cooling channels. In this case, the cooling channels also constitute the lines of the charging train.

Suitably, the two rectangular conductors are fluidically connected together via a hollow sealing profile made of insulation material and connecting the openings. The insulation material may for example be EPDM (ethylene-propylene-diene (monomer) rubber). This firstly ensures the electrical insulation between the two rectangular conductors. The hollow sealing profile may also establish a mechanical spacing between the two rectangular conductors. Secondly, the deflector is implemented by the hollow sealing profile, wherein simultaneously it is ensured that the openings are sealed against an escape of immersion fluid.

In a second alternative, cooling of the at least one line of the charging train takes place by the cooling channel arrangement with external cooling. For this, it is provided that at least one cooling channel, which preferably consists of electrically insulating material or has an electric insulating layer on its outer wall, adjoins the charging train superficially on the outside. Suitably, the cooling channels of the cooling channel arrangement have a profile which is inverse to the at least one line of the charging train. This ensures a good thermal transfer to the immersion fluid.

The electrical insulation of the at least one conductor and the cooling channel arrangement is alternatively achieved if at least one line of the charging train is externally insulated. The cooling channels in which the immersion fluid is conducted may be made of ceramic or plastic, and be pressed directly onto the charging train line or lines formed without insulation. The at least one line is preferably configured as a round conductor.

The invention is explained in more detail below with reference to an exemplary embodiment shown in the drawing.

### BRIEF DESCRIPTION OF THE DRAWINGS

FIG. 1 shows a partial perspective illustration of a charging train of a charging train device according to the present disclosure which is cooled by internal cooling;

FIG. 2 shows a side section through the charging train device from FIG. 1;

FIG. 3 shows a section from above and a plan view from above through the charging train according to FIG. 1;

FIG. 4 shows a perspective, exploded illustration of the charging train shown in FIG. 1 in connection with the elements of a vehicle-side charging interface;

FIG. 5 shows a section through a charging train of the charging train device according to the present disclosure which is cooled by external cooling; and

FIG. 6 shows a plan view of a charging train of the charging train device according to the present disclosure which is cooled by external cooling.

### DETAILED DESCRIPTION OF THE DRAWINGS

The charging train device described below is intended for use in a charging system, via which a battery (not shown) of an electrically powered motor vehicle (also not shown) can be charged. By the battery, electrical energy can be provided for an electric drive of the motor vehicle in order to drive the motor vehicle, which is in particular an electric vehicle. To charge the battery, the motor vehicle must be connected to a vehicle-external charging station (not shown), which provides electrical energy for the motor vehicle. Here, the charging station can provide the electrical energy for the motor vehicle conductively or inductively. The motor vehicle has a vehicle-side charging interface (not shown in the figures), by which the electrical energy provided by the charging station can be received.

To conduct the electrical energy further from the vehicle-side charging interface to the battery, the charging train device 1 is provided, which is described in more detail below. The charging interface is configured as a charging socket in the examples below. In the following figures, the charging train device 1 is shown purely in extract at its end on the charging interface side. The battery-side end is formed correspondingly so is not shown in the drawing.

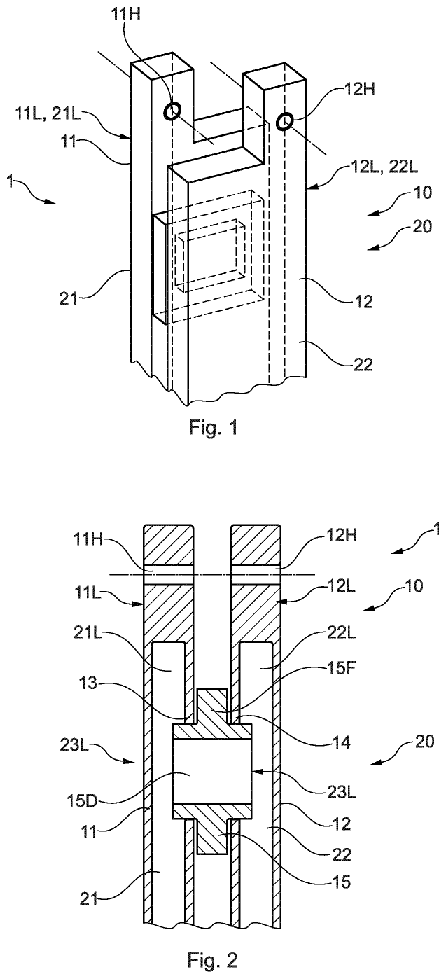

The charging train device 1 shown in various views in FIGS. 1 to 4 is based on the principle of internal cooling. This means that the line pair forming the charging train 10, comprising a first line 11 and a second line 12, simultaneously forms a cooling channel pair of a cooling channel arrangement 20 which comprises a first cooling channel 21 and a second cooling channel 22. For this, the first and second lines 11, 12 are formed as hollow conductors, so that a cooling fluid of the cooling channel arrangement 20 can be guided in the interior of the hollow conductors. An electrically insulating immersion fluid, e.g. a fluorine- or paraffin-based oil, is used as a cooling fluid, so accordingly the interior of the first and second lines 11, 12 formed as hollow conductors may be configured without electrical insulators.

The cooling channel arrangement is configured as a closed cooling circuit. A deflector is provided at each end of the lines 11, 12 or cooling channels 21, 22 on the battery side (not shown) and on the charging interface side. The ends of the lines 11, 12 on the charging interface side are designated as charging interface side ends 11L, 12L. The ends of the cooling channels 21, 22 on the charging interface side are designated as charging interface side ends 21L, 22L. The charging interface side ends 11L, 12L of the lines 11, 12, and the charging interface side ends 21L, 22L of the cooling channels 21, 22, may be provided in a connecting element which is not shown in detail.

In the present FIGS. 1 to 4, only the charging interface side deflector 23L is illustrated, wherein the statements below apply similarly to the battery-side deflector. By the deflector 23L, the cooling fluid can be deflected from one of the cooling channels 21 or 22 into the other of the two cooling channels 22 or 21. The cooling fluid is conveyed in the cooling circuit via a pump (not shown in the figures) which is preferably arranged in an expansion vessel of the cooling circuit. This may be arranged for example on the battery side. The pump draws in cooling fluid from one of the cooling channels 21 or 22 and expels the cooling fluid into the other of the two cooling channels 22 or 21.

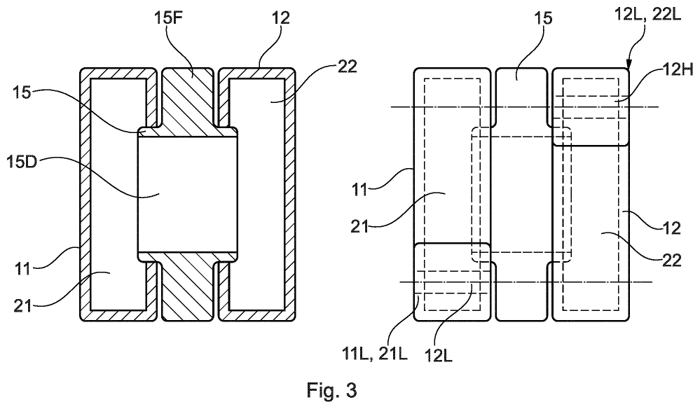

The deflector 23L is made from a hollow sealing profile 15 of an insulating material, in particular EPDM, which fluidically connects together the first and second cooling channels 21, 22. In order to make the connection of the first and second cooling channels 21, 22 via the hollow sealing profile 15 as simple as possible, it is suitable if the first and second lines 11, 22 are designed as rectangular conductors. This is particularly evident from FIGS. 1 and 3. In principle, it is sufficient to shape the first and second lines 11, 12 only in a portion at their respective ends on the battery side (not shown) and on the charging interface side (i.e. in the region of the charging interface side ends). For production reasons, it is preferred to form the first and second lines 11, 12 as rectangular conductors over their entire length. Thus the lines 11, 12 formed as rectangular conductors can be arranged lying one above the other over their entire length, so that a constant spacing exists between the first and second lines 11, 12 over the entire length.

In the region of the hollow sealing profile 15, the first line 11 and the second line 12 each have an opening 13, 14, which face one another when the rectangular conductors lie one above the other. The hollow sealing profile 15 protrudes slightly into the respective openings 13, 14, wherein a passage 15D of the hollow sealing profile 15 fluidically connects the first cooling channel 21 to the second cooling channel 22. The openings 13, 14 are sealed via a flange 15F of the hollow sealing profile 15 running around the passage. Furthermore, a distance between the rectangular conductors lying one above the other can be established by the thickness of the flange 15F of the hollow sealing profile.

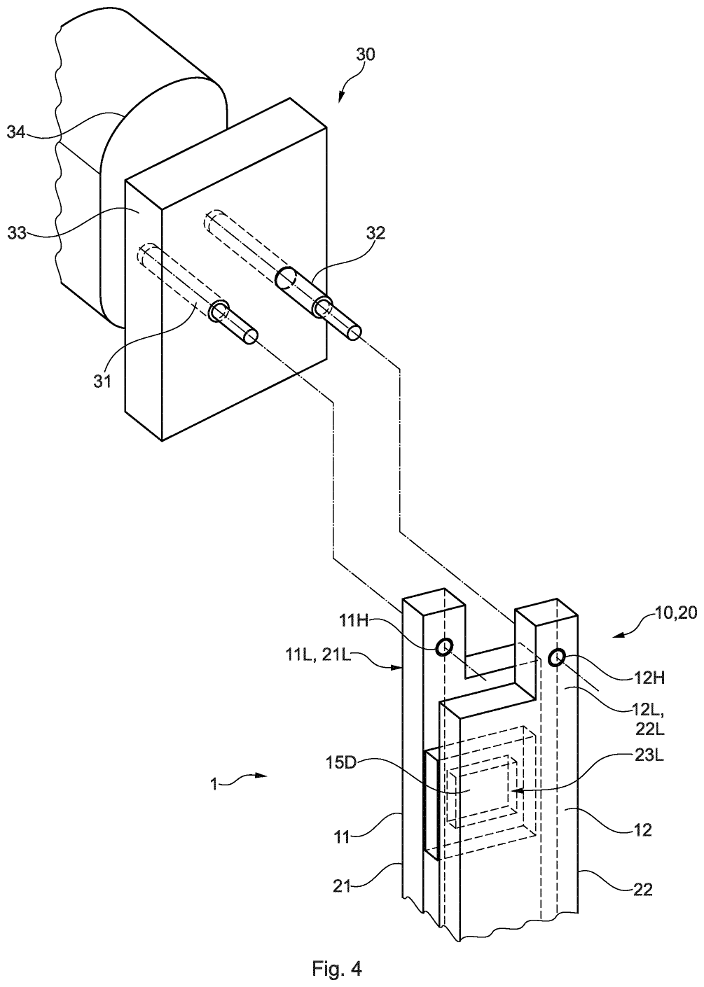

As most clearly shown from FIGS. 1 and 4, the first line 11 and the second line 12 at their charging interface side ends 11L, 12L have a constriction lying on opposite sides in a direction transversely to the extent direction of the charging train 10. The respective constrictions are provided with a bore 11H and 12H in which contact pins 31, 32 of the charging interface 30 can be inserted. The contact pins 31, 32 are for example mechanically connected to a base plate 33 of the charging interface 30 made of insulating material, so that the ends of the contact pins 31, 32 not protruding into the bores 11H, 12H can open into a contact cup 34 of the charging interface 30 (see FIG. 4). Thus any electrical connection can easily be created by force fit and/or form fit. Connection via substance flow is also conceivable.

The charging train device can thus be connected to the charging interface 30 in a simple mechanical fashion with a small number of components. A corresponding connection is also possible on the battery side.

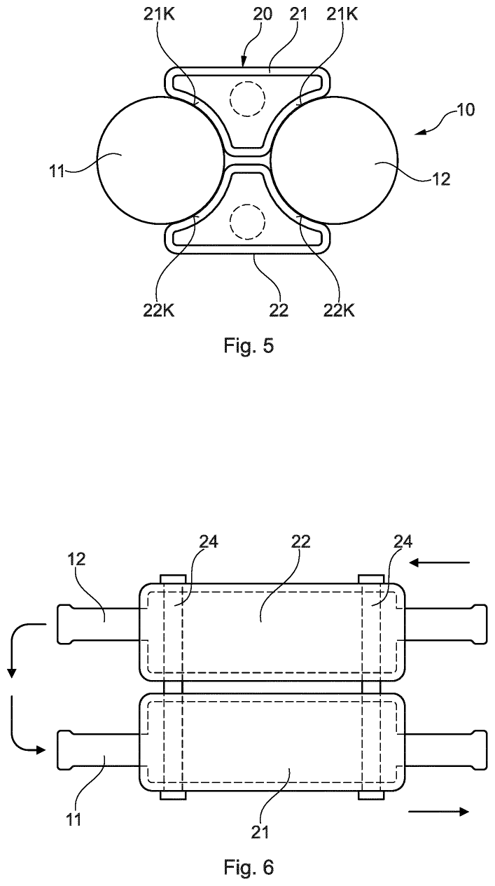

In a further embodiment shown in FIGS. 5 and 6, cooling of the first and second lines 11, 12 is possible via external cooling. In this exemplary embodiment, the lines 11, 12 are designed as round conductors, i.e. conductors with round cross-section. Other cross-sectional shapes are also possible. The cooling channel arrangement 20 comprises the two cooling channels 21 and 22 which have an external profile inverse to the round conductors 11, 12, so that their respective circular contact faces 21K, 22K can lie externally closely against the round conductors 11, 12. The immersion fluid circulates in the interior of the cooling channels 21, 22, flowing in the cooling channels in opposite directions.

The cooling channels 21, 22 preferably consist of an electrically insulating material, e.g. a ceramic or plastic. Since the cooling fluid is also not electrically conductive, the round conductors 11, 12 can therefore be formed without external insulation. The cooling channels can thus be applied directly to the bright metal of the first and second lines 11, 12.

The round conductors 11, 12 run parallel to one another as described above. A respective cooling channel 21, 22 with profile inverse to the circular profile can be inserted from both sides into the space between the first and second conductors 11, 12, so that the two round conductors 11, 12 are in contact with the outer wall of the cooling channel pair in a circle segment of up to 180°. The cooling channel pair can be pressed against one another by a mechanical connecting element 24, e.g. a cable tie or clamp, to improve the heat transfer.

In the plan view of FIG. 6, the cooling channel arrangement consists of two cooling channels with surface profile inverse to the lines 11, 12, both of which channels are applied to the lines 11, 12 from the same side. Optionally, a further cooling channel pair can be laid on the lines 11, 12 from the opposite side.

The cooling channel arrangement 20 in this embodiment is formed as a closed cooling circuit, wherein the cooling fluid is conveyed in the cooling circuit by a pump. The cooling fluid can be deflected from one of the cooling channels into the other of the two cooling channels by corresponding deflectors on the battery side and on the charging interface side (not shown).

The cooling circuit may be a cooling circuit separate from the battery cooling circuit. The cooling circuit may be connected to the battery cooling circuit.

### LIST OF REFERENCE SIGNS

1 Charging train device
10 Charging train
11 First line
11L End of first line 11 on charging interface side
11H Bore on charging interface side end of first line 11
12 Second line
12L End of second line 12 on charging interface side
12H Bore on charging interface side end of second line 12
13 Opening on charging face side end of first line 11
14 Opening on charging face side end of second line 12
15 Hollow sealing profile
15D Passage of hollow sealing profile
15F Flange of hollow sealing profile
20 Cooling channel arrangement
21 First cooling channel
21K Contact face
22 Second cooling channel
22K Contact face
21L End of first cooling channel 21 on charging interface side
22L End of second cooling channel 22 on charging interface side
23L Charging interface side deflector
24 Connecting element
30 Charging interface
31 Contact pin
32 Contact pin
33 Base plate
34 Contact cup

1-13. (canceled)

14. A charging train device for a battery of a motor vehicle, comprising:
a charging train comprising:
at least one line and respective ends on a battery side and on a charging interface side configured to connect to a vehicle-external charging station; and
a cooling channel arrangement arranged in the charging train and configured to allow a cooling fluid to flow therethrough and which comprises at least one cooling channel,
wherein the cooling fluid is an immersion fluid.

15. The charging train device according to claim 14,
wherein the at least one line comprises a line pair consisting of a first line and a second line.

16. The charging train device according to claim 14,
wherein at least one cooling channel of the cooling channel arrangement comprises a cooling channel pair consisting of a first cooling channel and a second cooling channel.

17. The charging train device according to claim 14,
wherein the cooling channel arrangement is configured as a closed cooling circuit,
wherein the at least one cooling channel comprises at least two cooling channels, and
wherein a deflector is provided at the respective ends on the battery side and on the charging interface side, wherein the deflector is configured to deflect the cooling fluid from at least one of the at least two cooling channels into at least another of the at least two cooling channels, wherein the cooling fluid is conveyed in the cooling circuit via a pump.

18. The charging train device according to claim 17,
wherein the pump is arranged in an expansion vessel of the cooling circuit which conveys the cooling fluid in the circuit through the at least two cooling channels.

19. The charging train device according to claim 17,
wherein the cooling circuit is a cooling circuit independent of a battery cooling.

20. The charging train device according to claim 14,
wherein the at least one line of the charging train is a hollow conductor, wherein the cooling fluid is conveyed in an interior of the hollow conductor.

21. The charging train device according to claim 20,
wherein an inner wall of the hollow conductor is configured without an electrical insulator.

22. The charging train device according to claim 20,
wherein the at least one line of the charging train is each formed as a rectangular conductor, at least in a portion at its respective ends on the battery side and on the charging interface side.

23. The charging train device according to claim 22,
wherein the at least one line comprises a plurality of lines, and
wherein the rectangular conductors lie one above the other.

24. The charging train device according to claim 22,
wherein each rectangular conductor has an opening at its respective ends on the battery side and/or the charging interface side, which openings face one another.

25. The charging train device according to claim 24,
wherein the at least one line comprises at least two lines, and
wherein the rectangular conductors of the at least two lines are fluidically connected together via a hollow sealing profile made of insulation material connecting the openings.

26. The charging train device according to claim 22,
wherein the at least one line of the charging train is each formed as the rectangular conductor over its entire length.

27. The charging train device according to claim 26,
wherein the at least one line comprises a plurality of lines, and
wherein the rectangular conductors lie one above the other.

28. The charging train device according to claim 26,
wherein each rectangular conductor has an opening at its respective ends on the battery side and/or the charging interface side, which openings face one another.

29. The charging train device according to claim 28,
wherein the at least one line comprises at least two lines, and
wherein the rectangular conductors of the at least two lines are fluidically connected together via a hollow scaling profile made of insulation material connecting the openings.

30. The charging train device according to claim 14,
wherein the at least one cooling channel adjoins the charging train superficially on an outside thereof.
